(19) United States
(12) Patent Application Publication
(10) Pub. No.: US 2009/0033501 A1
(43) Pub. Date: Feb. 5, 2009

(54) ONLINE MONITORING METHOD OF DRIVER STATE AND SYSTEM USING THE SAME

(75) Inventors: Liang-Kuang Chen, Taipei City (TW); Meng-Hsuan Peng, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei City (TW)

(21) Appl. No.: 12/179,528

(22) Filed: Jul. 24, 2008

(30) Foreign Application Priority Data
Jul. 31, 2007 (TW) 96127932

(51) Int. Cl. G08B 23/00

(52) U.S. Cl. 340/576

(57) ABSTRACT

An online monitoring method of driver state and a system using the same are provided. First a driver model is established, wherein the driver model generates a steering angle to control transportation means for riding according to the lateral position error of the riding transportation means. Next, a system identification processing is performed on the lateral position error and the steering angle of the riding transportation means to obtain a transfer function of the driver model. After that, an analysis processing is performed on the driver model transfer function to extract specific information therefrom, following by performing an assessment processing on the specific information and multiple statistics of raw data to generate the driver state assessment.

### CROSS-REFERENCE TO RELATED APPLICATION

This application claims the priority benefit of Taiwan application serial no. 96127932, filed on Jul. 31, 2007. The entirety of the above-mentioned patent application is hereby incorporated by reference herein and made a part of this specification.

### BACKGROUND OF THE INVENTION

1. Field of the Invention

The present invention generally relates to an online monitoring method of driver state and a system using the same, and more specifically, to a monitoring method and a system using the information obtained from an online driver model identification to generate the driver state assessment.

2. Description of Related Art

The upgrowth of traffic and transportation accelerates local developments, but the traffic accidents caused by improperly manipulated transportation means have become major factors to hazard public safety. Therefore, monitoring human driving behavior effectively and instantaneously, and further providing warning signals or other countermeasures for the improper driving behavior through a safety system are highly needed today.

Generally there are four common methods of monitoring driving behavior in the present state of the art. The first method is to monitor the manipulating and controlling commands issued by the human drivers. For example, the drowsiness level of a driver can be judged by monitoring the steering command interval of a driver, or judged according to the exerting effort from a driver to grasp his steering wheel, or to control the gas and brake pedals.

The second type of driver monitoring method is to observe the physical expressions of a driver. For example, the exogenous or inherent physiological expression of a driver is observed. The exogenous physiological expressions herein include, for example, eye closure, eye gazing direction, or head movement of a driver. A novel facial image detection system ‘FaceLAB’ developed by SeeingMachines Co. is an example of driver monitoring systems based on this type of method, where the driver state is judged according to the above-mentioned expressions. However, the observation method requires continuous image processing, wherein in addition to requiring additional imaging equipments, the judgment accuracy is also affected by the limitations of the image processing. On the other hand, the method using inherent physiological expressions, such as EEG (electroencephalograph) waves or heart beats of a driver, not only requires complex and expensive medical instruments to be worn by a driver, but also interferes with the vehicle driving.

The third method is to observe the relevant motion states of a vehicle. U.S. Pat. No. 7,034,697 provides an ‘awakening level estimation apparatus for a vehicle and method thereof’. According to the patent, a segment of the lateral displacement amount of the vehicle motion is converted into frequency domain, followed by calculating the power distributions in frequency domain thereof. Then, the average and the maximum value of the frequency component powers, the high-frequency percentile value, low-frequency percentile value and the correction factor thereof are calculated. Finally, the awakening level of the driver is determined by performing an estimation processing and a decision processing.

The fourth method is to establish a driver control model based on the manipulating behavior of the driver, followed by analyzing the resultant driver model. U.S. Pat. No. 7,206,697 provides a ‘driver adaptive collision warning system’, wherein several parametric models corresponding to various driving patterns are established in advance according to different driving styles and preferences. Various vehicle motion variables are served as the inputs to the parametric models and the values of the driver parametric model are calculated during vehicle driving so as to judge the driver state thereby.

In addition, the research article ‘Identification of driver state for lane-keeping tasks’ (IEEE Trans. On Systems, Man and Cybernetics, Vol. 29, No. 5, September 1999, pp. 486-502) reports a driver control model using an auto-regression with exogenous inputs model (ARX model), for estimating the fatigue level of a driver, wherein the ARX model is correlated to the steering angle command and the lateral position error of a riding vehicle.

The research article ‘Detecting driver inattention in the absence of driver monitoring sensors’ (Proceeding of the 2004 International Conference on Machine Learning and Application, ICMLA '04, pp. 220-226) provides a method that a driving simulator is used to collect dynamic information of a vehicle, followed by using the information to train two classifiers for judging different driver state, wherein the method classifies driver states into two types (attention and inattention) or three types (attention, inattentive to the left and inattentive to the right).

The paper ‘Reliable method for driving events recognition’ (IEEE Transaction on Intelligent Transportation Systems, v 6, n 2, June, 2005, p 198-205) provides a method that a hidden Markov model (HMM) is established by collecting information of longitudinal and lateral acceleration, riding speed and the like for determining driving behaviors through judging various driving event patterns.

The paper ‘Driver's Eye State Detecting Method Design Based On Eye Geometry Feature’ (IEEE Intelligent Vehicles Symposium, Proceedings, 2004 IEEE Intelligent Vehicles Symposium, 2004, p 357-362′) provides a method that a three-layered back-propagating neural network is used and the extent of eyesight of a driver is taken as a characteristic parameter to judge that the driver is in alert state, drowsy state or asleep state.

The investigation thesis ‘Estimating Driving Performance Based On EEG Spectrum And Fuzzy Neural Network’ (IEEE International Conference on Neural Networks—Conference Proceedings, v 1, 2004 IEEE International Joint Conference on Neural Networks—Proceedings, 2004, p 585-590) provides a method which combines a main component analysis with a neural network system of fuzzy-logic type for establishing a driver's fatigue-assessing system, and further uses lane-keeping simulated experiments to verify the feasibility of the system.

However, the above-mentioned methods are established using only the dynamic performance of a vehicle, or external human driver expressions. The driver state is assessed without considering the dynamic response characteristics of the human driver, so that the system performance during varying driving behavior in relation to the methods may be ambiguous or unacceptable, which makes correctly judgment of driver states unfeasible.

### SUMMARY OF THE INVENTION

Accordingly, the present invention is directed to an online monitoring method of driver state and a system using the same, which is able to correctly assess a driver state according to real-time driving data and dynamic information of a vehicle.

The present invention provides an online monitoring method of driver state. First, a driver model is established, wherein the driver model generates a steering angle to control transportation means according to the lateral position error of a riding transportation means. Next, a system identification processing on the lateral position error and the steering angle is performed so as to obtain the transfer function of the driver model. After that, an analysis processing on the transfer function is performed for extracting specific information therefrom. Further, an assessment processing on the specific information and multiple statistics of raw data is performed to generate the driver state assessment.

The present invention also provides an online monitoring system of driver state, which includes a system identification module, an analyzing module and an assessment module. The system identification module establishes a driver model and performs a system identification processing on the lateral position error and the steering angle of a riding transportation means for obtaining a transfer function of the driver model. The analyzing module is coupled to the system identification module to analyze the transfer function and extract specific information. The assessment module performs an assessment processing on the specific information and multiple statistics of raw data to generate the driver state assessment.

The present invention adopts lateral position error and steering angle to establish a driver model, wherein the instantaneous driving manipulating behavior and the dynamic performance of a vehicle and are considered the influence on the driver state assessment; plus, the present invention obtains the transfer function of the driver model by performing a system identification processing and further extracts the specific information containing the dynamic response characteristics of the vehicle by analyzing the transfer function. By performing an assessment processing on the specific information and the statistics of raw data, the driver state can be assessed instantaneously and correctly.

### BRIEF DESCRIPTION OF THE DRAWINGS

The accompanying drawings are included to provide further understanding of the invention, and are incorporated in and constitute a part of this specification. The drawings illustrate embodiments of the invention and, together with the description, serve to explain the principles of the invention.

FIG. 1 is a block diagram of online monitoring system of driver state according to an embodiment of the present invention.

FIG. 2 is a diagram of the system identification module in FIG. 1 according to an embodiment of the present invention.

FIG. 3A is a table listing different driver state corresponding to each of intervals.

FIG. 3B is a curve diagram of the changes of main frequency of steering angles over time.

FIG. 3C is a curve diagram of the changes of DC gain over time.

FIG. 3D is a curve diagram of the changes of phase lead over time.

FIG. 3E is a curve diagram of the changes of crossover frequency over time.

FIG. 4 is a diagram of classifying by conducting the processing of a probability neural network (PNN).

FIG. 5A is a curve diagram of the probability density functions of the standard derivation of steering angle δ corresponding to various driver states.

FIG. 5B is a curve diagram of the probability density functions of the standard derivation of the main frequency of steering angle δ corresponding to various driver states.

FIG. 6 is a schematic flowchart of an assessment processing according to an embodiment of the present invention.

FIGS. 7A-7D are curve diagrams of possibility indexes corresponding to normal driver state, panic driver state, nervous driver state and un-alert driver state.

FIG. 8 is a table listing judgment error rates corresponding to various driver states according to an embodiment of the present invention.

FIG. 9 is a flowchart showing the online monitoring method of driver state according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

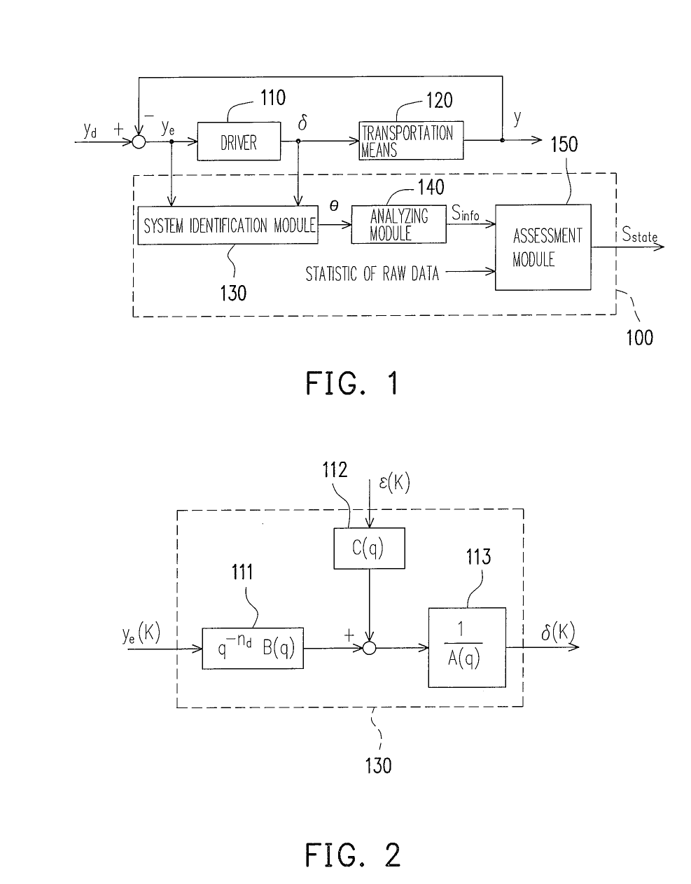

FIG. 1 is a block diagram of online monitoring system of driver state according to an embodiment of the present invention. Referring to FIG. 1, a monitoring system 100 includes a system identification module 130, an analyzing module 140 and an assessment module 150. The system identification module 130 establishes a driver model therein, and the driver model is that a driver 110 is assumed to produce a steering angle δ according to a lateral position error yₑ to control a transportation means 120 (for example, a vehicle) to ride, wherein the lateral position error yₑ is the difference between a real path y and a predetermined path y_{d} of the riding transportation means 120. The steering angle δ is an angle signal to manipulate a steering wheel. The system identification module 130 performs a system identification processing on the lateral position error yₑ and the steering angle δ to obtain a transfer function of the driver model.

The analyzing module 140 is coupled to the system identification module 130 for analyzing the transfer function of the driver model to extract the specific information S_{info} therefrom. The assessment module 150 performs an assessment processing on the specific information S_{info} and multiple statistics of raw data to generate the driver state assessment S_{state.}

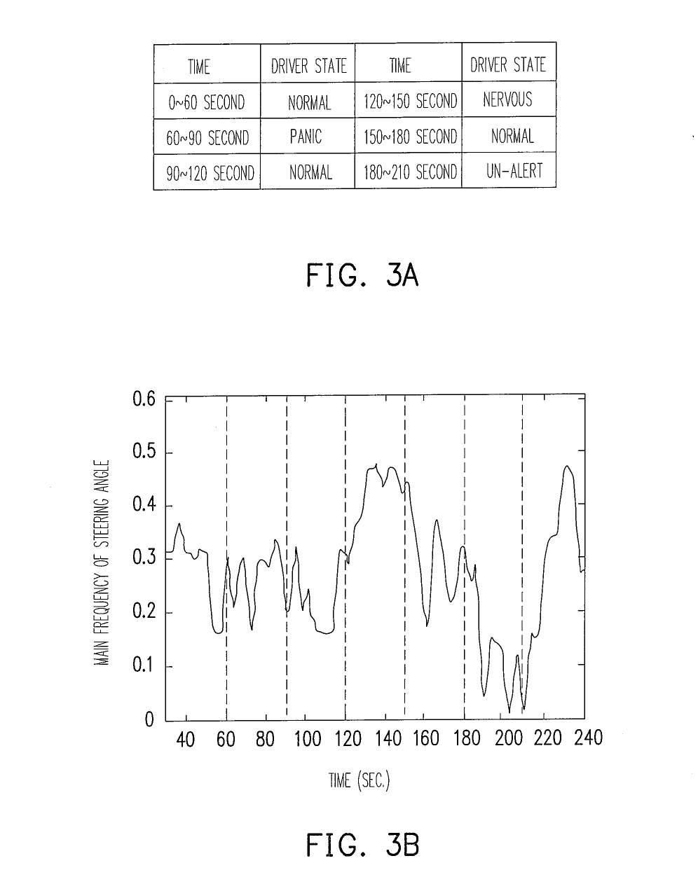

FIG. 2 is a diagram of the system identification module in FIG. 1 according to an embodiment of the present invention. The driver model established by the system identification module 130 is considered as a model for the driver 110 to manipulate the transportation means 120. It is assumed herein the driver model of the embodiment is an auto-regression moving average with exogenous inputs model (ARMAX model). Referring to FIG. 2, the driver model includes transfer units 111-113 and the driver model can be expressed by A(q)×δ(k)=B(q)×yₑ(k−n_{d})+C(q)×ε(k), wherein A(q), B(q) and C(q) are respectively the polynomials in forward shift operator q, k is sampling frequency (for example, 10 Hz), and n_{d} and ε are respectively the delay and the residual value of the driver model.

For the convenience of executing a system identification processing, the driver model is assumed to be an ARMAX model with the second order, i.e., A(q)=1+a₁q⁻¹+a₂q⁻², B(q)=b₁+b₂q⁻¹, C(q)=1+c₁q⁻¹. The system identification processing herein uses an extended recursive least square algorithm (ERLS algorithm) so as to obtain a predicted steering angle δ and a predicted error according to a regressor and further to obtain a parameter vector θ, wherein the parameter vector θ includes the estimation values of the parameters a₁, a₂, b₁, b₂ and c₁ of the above-mentioned polynomials. In this way, after performing a system identification processing on the lateral position error ye and the steering angle δ by the system identification module 130, the transfer function, Gd=q⁻¹×(b₁+b₂q⁻¹)/(1+a₁q⁻¹+a₂q²), of the driver model can be obtained.

The analyzing module 140 further performs an analysis processing on the transfer function so as to extract specific information S_{info} containing the dynamic response characteristic of the driver 110 therefrom, wherein the specific information S_{info} is, for example, phase lead, maximal phase lead, DC gain, crossover frequency or main frequency of the steering angle δ.

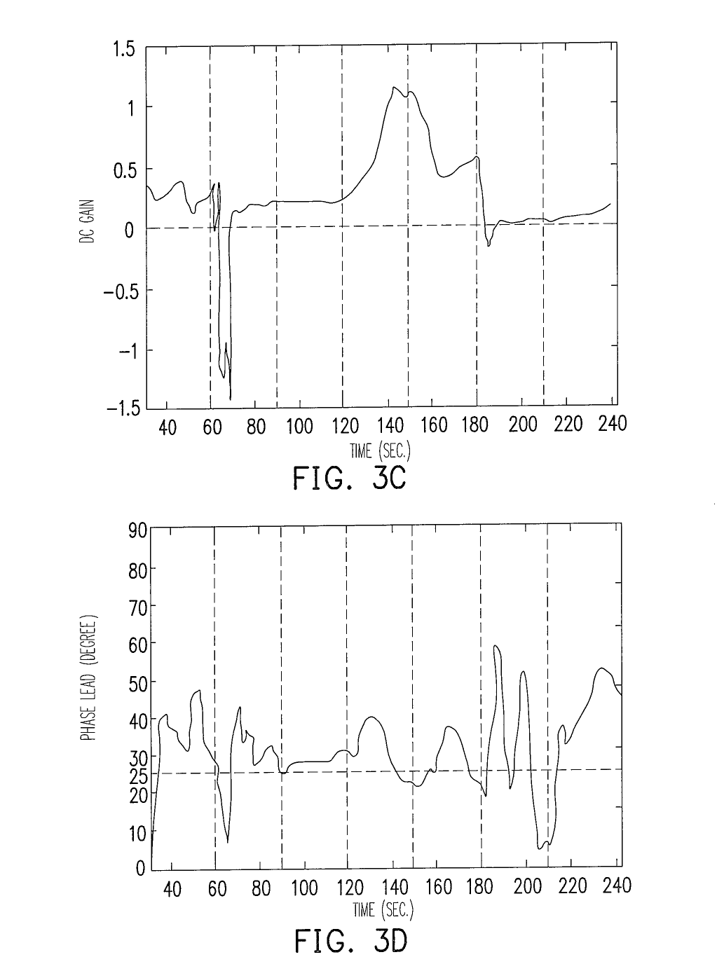

After the analysis processing step, for example, the signal of the steering angle δ is converted by a discrete Fourier transform (DFT) into a frequency spectrum thereof, and the main frequency thereof is served as the specific information S_{info}. Assuming the driver states for the driver 110 to control the transportation means riding 120 are shown by FIG. 3A, the main frequency of the steering angle δ corresponding to each time interval may have a little variation.

FIG. 3B is a curve diagram of the changes of main frequency of steering angle over time. In order to make the curve formed by data points smooth to easily observe the curve tendency, the data points of the main frequency of the steering angle δ with five seconds lag moving average are plotted in FIG. 3B. Referring to FIGS. 3A and 3B, when the driver state is normal which is corresponding to, for example, 0-60 sec., 90-120 sec. and 150-180 sec., the main frequencies of the steering angle δ are usually within 0.2 Hz-0.3 Hz; when the driver state is nervous which corresponds to 120-150 sec., the main frequencies of the steering angle δ are increased to 0.4 Hz-0.5Hz; when the driver state is un-alert which corresponds to, for example, 180-210 sec., the main frequencies of the steering angle δ are reduced to 0.1 Hz.

An intuitive deduction can be made herein that when the driver state is nervous, the driver may more frequently but in a small deviation adjust the steering angle δ of a steering wheel which increases the main frequency of the steering angle δ. Contrarily, when the driver state is un-alert, the main frequency of the steering angle δ would be decreased. Therefore, the driving behavior is highly correlated to the main frequency of the steering angle δ, and the main frequency of the steering angle δ is able to be used for behavior pattern recognition of the driver.

In addition, the phase lead is closely related to the robustness and the stability of the closed loop monitoring system 100. Moreover, the DC gain is related to tracking accuracy and speed. The crossover frequency is usually the preferable approximation of the bandwidth of the monitoring system 100 and served to indicate the un-alert extent. In order to achieve the real-time processing goal, the embodiment adopts the maximal phase lead as the indicative phase lead of the driver model and adopts the occurring frequency of the maximal phase lead as the estimated crossover frequency.

FIG. 3C is a curve diagram of the changes of DC gain over time, FIG. 3D is a curve diagram of the changes of phase lead over time and FIG. 3E is a curve diagram of the changes of crossover frequency over time, wherein the data points of the DC gain, the phase lead and the crossover with five seconds lag moving average are respectively plotted in FIGS. 3C, 3D and 3E. Referring to FIGS. 3B-3E, corresponding to an interval of a normal driver state, the driver model usually gives out high enough DC gains, phase leads, crossover frequencies and main frequencies of the steering angle δ. Corresponding to an interval of a panic driver state, the DC gain and the phase lead have a quick fluctuation; in particular, the DC gain would turn to a negative value. Corresponding to a transient interval of the driver state from a normal state to a panic state, the crossover frequency turns to a lower value.

During an interval of a nervous driver state, the DC gain, the crossover frequency and the main frequency of the steering angle δ turn to abnormal high values. Although the phase lead and the crossover frequency corresponding to both a nervous driver state and a normal driver state are similar to each other (i.e. the same increasing tendency), but the above-mentioned two states are able to be distinguished from each other by the change of the DC gain. Besides, corresponding to an interval of un-alert driver state, the DC gain, the crossover frequency and the main frequency of the steering angle δ would turn to lower values.

It can be seen from FIGS. 3B-3E that the analyzing module 140 is able to extract specific information S_{info} containing the dynamic response characteristic of the driver 110 from the transfer function by performing an analysis processing step on the transfer function, and the specific information S_{info} may be one of the phase lead, the maximal phase lead, the DC gain, the crossover frequency and the main frequency of the steering angle δ.

The operation of the assessment module 150 is depicted in detail hereinafter. In order to correctly assess a driving state, a combination of various information sources must be considered. Thus, the assessment module 150 accordingly performs an assessment processing on the specific information S_{info} extracted from the analyzing module 140 and multiple statistics of raw data for generating the driver state assessment Sₛₜₐₜₑ. In the embodiment, the statistic of raw data may be the standard deviation (SD) or the average value of one of the residual value ε of the driver model established by the system identification module 130, the lateral position error yₑ, the steering angle δ, the yaw angle and roll angle.

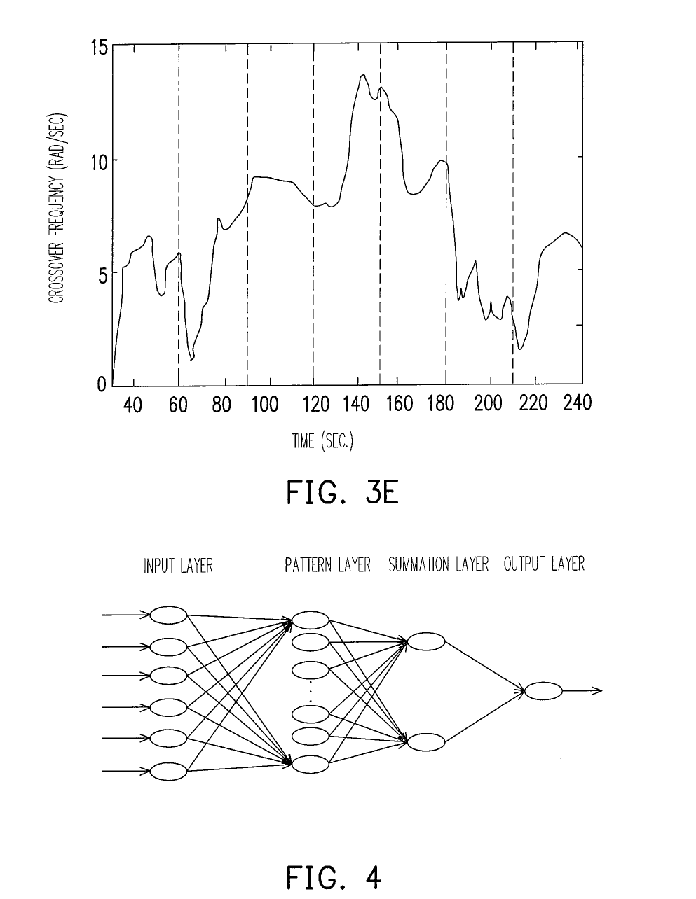

The embodiment herein adopts an architecture of probability neural network (PNN) to perform an assessment processing. FIG. 4 is a diagram of classification by conducting the processing of a probability neural network (PNN). Referring to FIG. 4, the embodiment adopts a four-layered feedforward neural network which includes an input layer, a pattern layer, a summation layer and an output layer. The pattern layer is to execute a kernel algorithm of the PNN so that the pattern layer sends a weight sum of the input vectors to a nonlinear function for calculation. By selecting a part of the above-mentioned specific information and statistic of raw data as input parameters and then training the PNN, the driver state is able to be effectively assessed.

The PNN established a decision tree mainly for training data, wherein the embodiment adopts Bayesian classification theory to assess and select any one (referred as a relevant variable) of the internal nodes of the decision tree to continuously serve as the base of branch, and furthermore, adopts kernel smoothing approach for obtaining the probability density function (PDF) of the relevant variable corresponding to various driver states.

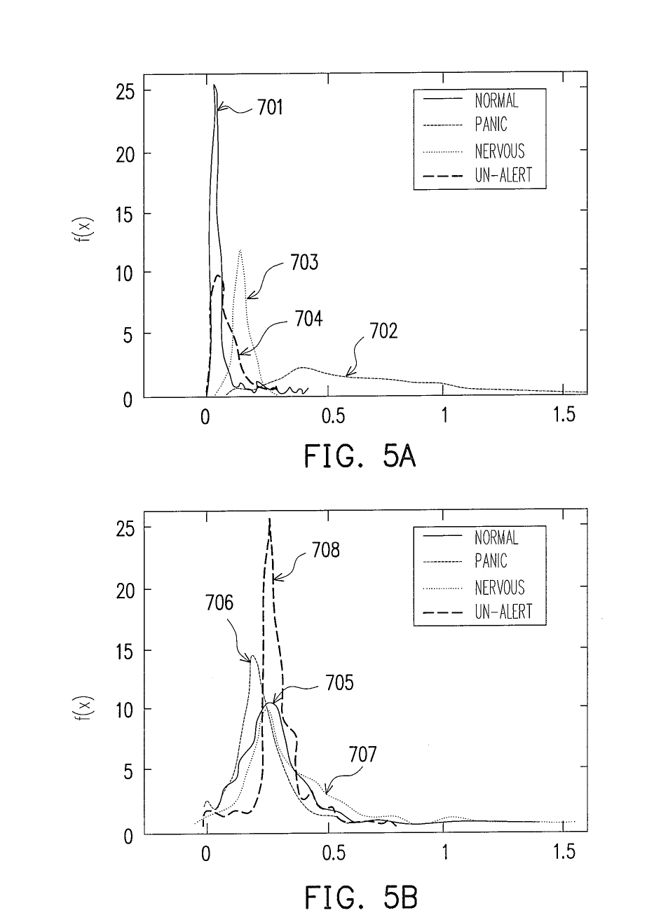

The selected relevant variables herein are, for example, the SD of the steering angle δ and the SD of the main frequency of the steering angle δ. FIG. 5A is a curve diagram of the probability density functions of the standard deviation of steering angle δ corresponding to various driver states. FIG. 5B is a curve diagram of the probability density functions of the standard deviation of the main frequency of steering angle δ corresponding to various driver states. Referring to FIG. 5A, the curves 501, 502, 503 and 504 are PDF distributions of the SD of the steering angle δ respectively corresponding to normal, panic, nervous and un-alert driver states. Referring to FIG. 5B, the curves 505, 506, 507 and 508 are PDF distributions of the SD of the main frequency of the steering angle δ respectively corresponding to normal, panic, nervous and un-alert driver states. It can be seen from FIGS. 5A and 5B, different driver states may be distinguished through the PDF distributions.

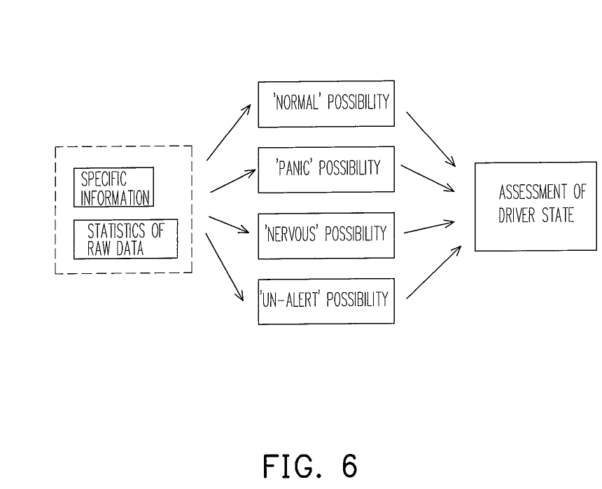

Considering a combination of various information sources (including the above-mentioned specific information S_{info} and the statistics of raw data) contributes to increase the correctness of the driver state assessment. FIG. 6 is a schematic flowchart of an assessment processing according to an embodiment of the present invention. Referring to FIG. 6, the embodiment uses a set of variables to train the PNN, wherein the set of variables includes, for example, the SD of steering angle δ, the average value of the main frequency of the steering angle, the SD of the lateral position error yₑ, the SD of the residual value ε of the driver model and the average value of the DC gain.

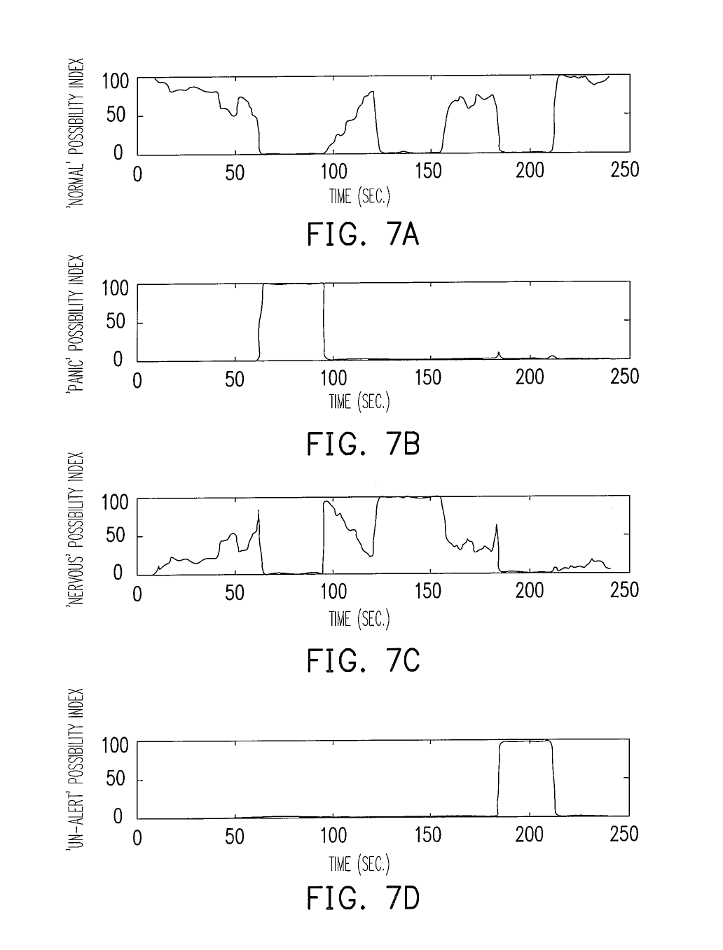

After the information of a driver model is online identified and all variable values in the said set of variables are obtained, the PNN would analyze the possibilities of the set of variables respectively corresponding to normal, panic, nervous or un-alert driver state and then generate the most possible driver state assessment according to the possibility indexes corresponding to various driver states. FIGS. 7A-7D are curve diagrams of possibility indexes corresponding to normal driver state, panic driver state, nervous driver state and un-alert driver state. Referring to FIGS. 7A-7D, the driver state during a specific interval may be decided according to the possibility index. For example, during 60 sec.-90 sec., the possibility index corresponding to panic driver state is higher than other states, while during 180 sec.-210 sec., the possibility index corresponding to un-alert driver state is higher than other states.

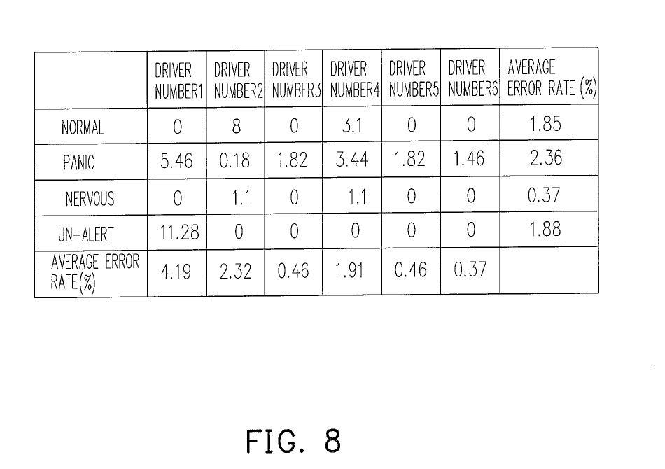

The correctness of the driver state assessment in the said embodiment is verified by using a driving simulator manipulated by unspecific drivers. FIG. 8 is a table listing error rates of driver state assessment corresponding to various driver states according to an embodiment of the present invention. Referring to FIG. 8, the experiment results indicate that the approach based on the PNN trained by the above-mentioned set of variables has average error rates of 1.85%, 2.36%, 0.37% and 1.88% respectively corresponding to normal, panic, nervous and un-alert driver states, which suggests the scheme considering driver manipulating behaviour (i.e. steering angle) and vehicle dynamic information (i.e. lateral position error) to observe the dynamic response characteristic of a driver is quite correct for driver state assessment.

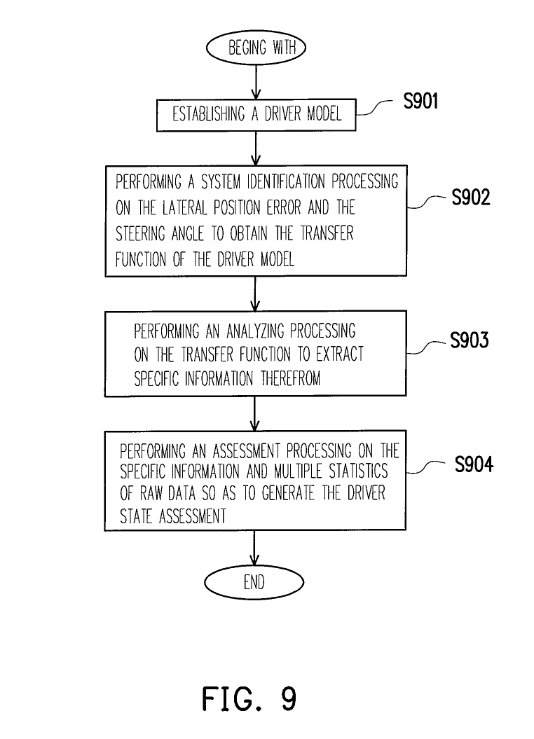

According to the depictions of the above-mentioned embodiments, the flowchart of the monitoring method can be summarized as follows. FIG. 9 is a flowchart showing the online monitoring method of driver state according to an embodiment of the present invention. Referring to FIGS. 1 and 9, first, a driver model is established by the system identification module 130 (step S901), wherein the driver model would generate a steering angle δ to control the transportation means 120 for riding according to the lateral position error Ye of the transportation means 120. Next, a online system identification processing on the real lateral position error yₑ and the real steering angle δ of a riding transportation means 120 is performed to obtain the transfer function of the driver model (step S902). After that, an analysis processing on the transfer function is performed to extract specific information therefrom (step S903). Further, an assessment processing on the specific information and multiple statistics of raw data is performed so as to generate the driver state assessment.

In summary, a lateral position error and a steering angle are used to establish a driver model and the instantaneously driving manipulating behavior and the dynamic performance of a transportation means as taken one of factors for judging driver state assessment, and furthermore, an online system identification processing is performed to obtain the parameters of the driver model and thereby to obtain the transfer function of the driver model. In order to observe the dynamic response characteristic of a driver, an analysis processing on the transfer function is performed for obtaining the specific information is obtained, wherein the specific information includes, for example, main frequency of the steering angle, DC gain, crossover frequency or phase lead and all the information contributes to assess a driver state.

Moreover, an assessment processing is performed on the specific information and the statistics of sampled raw data for generating the driver state assessment, wherein the statistics of raw data include, for example, the SD or the average value of residual value of the driver model, lateral position error, steering angle, yaw angle or roll angle. The assessment processing is implemented by using a PNN processing on the specific information and the statistics of raw data so as to obtain possibility indexes of the specific information and the statistics of raw data corresponding to various driver states for generating the driver assessment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An online monitoring method of driver state, comprising:
establishing a driver model, wherein the driver model generates a steering angle to control a transportation means for riding according to a lateral position error of the riding transportation means;
performing a system identification processing on the lateral position error and the steering angle to obtain a transfer function of the driver model;
performing an analysis processing on the transfer function to extract a specific information therefrom; and
performing an assessment processing on the specific information and multiple statistics of raw data to generate a driver state assessment.

2. The online monitoring method of driver state according to claim 1, wherein the step of establishing the driver model comprises:
multiplying the lateral position error by a first polynomial with a forward shift operator to get a first product, multiplying a residual value of the driver model by a second polynomial with the forward shift operator to get a second product and adding the first and second products to obtain an equation; and
dividing the equation by a third polynomial with the forward shift operator to obtain the steering angle.

3. The online monitoring method of driver state according to claim 1, wherein the driver model is an auto-regression moving average with exogenous inputs model (ARMAX model).

4. The online monitoring method of driver state according to claim 1, wherein the lateral position error is the lateral difference between a real path of the riding transportation means and a predetermined path.

5. The online monitoring method of driver state according to claim 1, wherein the system identification processing comprises:
adopting an extended recursive least square algorithm (ERLS algorithm) to calculate a parameter vector of the driver model; and
obtaining the transfer function of the driver model according to the parameter vector.

6. The online monitoring method of driver state according to claim 1, wherein the step of analysis processing comprises:
calculating any one of a phase lead, a maximal phase lead, a DC gain, a crossover frequency and a main frequency of the steering angle of the transfer function and taking the calculation result as the specific information.

7. The online monitoring method of driver state according to claim 1, wherein the statistics of raw data comprise any one of a residual value of the driver model, the lateral position error, the steering angle, a yaw angle and a roll angle.

8. The online monitoring method of driver state according to claim 1, wherein the step of assessment processing comprises:
performing a probability neural network (PNN) processing on the specific information and the statistics of raw data to obtain a probability index corresponding to the driver state; and
generating the driver state assessment according to the possibility index.

9. An online monitoring system of driver state, comprising:
a system identification module for establishing a driver model and performing a system identification processing on a lateral position error and a steering angle of a riding transportation means to obtain a transfer function of the driver model;
an analyzing module, coupled to the system identification module for performing a analysis processing on the transfer function and extracting a specific information therefrom; and
an assessment module, coupled to the analyzing module for performing an assessment processing on the specific information and multiple statistics of raw data to generate a driver state assessment.

10. The online monitoring system of driver state according to claim 9, wherein the driver model comprises:
a first transfer unit for multiplying the lateral position error by a first polynomial with a forward shift operator;
a second transfer unit for multiplying a residual value of the driver model by a second polynomial with the forward shift operator; and
a third transfer unit for dividing the summation of two calculation results of the first transfer unit and the second transfer unit by a third polynomial with the forward shift operator to obtain the steering angle.

11. The online monitoring system of driver state according to claim 9, wherein the driver model is an auto-regression moving average with exogenous inputs model (ARMAX model).

12. The online monitoring system of driver state according to claim 9, wherein the lateral position error is a lateral difference between a real path of the riding transportation means and a predetermined path.

13. The online monitoring system of driver state according to claim 9, wherein the system identification processing is to adopt an extended recursive least square algorithm (ERLS algorithm) to calculate a parameter vector of the driver model and thereby to obtain the transfer function of the driver model.

14. The online monitoring system of driver state according to claim 9, wherein the analysis processing is employed for calculating any one of a phase lead, a maximal phase lead, a DC gain, a crossover frequency and a main frequency of the steering angle of the transfer function and taking the calculation result as the specific information.

15. The online monitoring system of driver state according to claim 9, wherein the statistics of raw data comprise any one of a residual value of the driver model, the lateral position error, the steering angle, a yaw angle and a roll angle.

16. The online monitoring system of driver state according to claim 9, wherein the assessment processing is employed for performing a probability neural network (PNN) processing on the specific information and the statistics of raw data to obtain a probability index corresponding to the driver state and generating the driver state assessment according to the possibility index.
